(19) United States
(12) Patent Application Publication
(10) Pub. No.: US 2026/0154541 A1
(43) Pub. Date: Jun. 4, 2026

(54) METHOD AND APPARATUS FOR TEXT PROCESSING BASED ON LARGE MODEL, AND METHOD AND APPARATUS FOR LARGE MODEL COMPRESSION

(71) Applicant: BEIJING BAIDU NETCOM SCIENCE TECHNOLOGY CO., LTD., Beijing (CN)

(72) Inventors: Yuping XU, Beijing (CN); Lei WU, Beijing (CN)

(73) Assignee: BEIJING BAIDU NETCOM SCIENCE TECHNOLOGY CO., LTD., Beijing (CN)

(21) Appl. No.: 19/459,971

(22) Filed: Jan. 26, 2026

(30) Foreign Application Priority Data
Jun. 3, 2025 (CN) 202510735386.9

(51) Int. Cl. G06N 3/0495

(52) U.S. Cl. CPC G06N 3/0495

(57) ABSTRACT

Method and apparatus for text processing based on large model, and method and apparatus for large model compression are disclosed, which relate to the technical field of artificial intelligence field such as deep learning, large model, and natural language processing. The method for text processing based on large model includes: obtaining a token sequence corresponding to an input text; performing the following processing respectively for respective tokens in the token sequence: in response to determining that a fusion layer in a target large model needs to be used to process a token, generating a target processing result corresponding to the token by executing inference computation in the fusion layer at least twice, wherein the target large model is obtained by performing a model compression on a large model to be compressed, the model compression includes fusing Lm consecutive layers in the large model to be compressed into the fusion layer, Lm is a positive integer greater than 1, and Lm is less than L, where L represents the number of layers included in the large model to be compressed.

The present application claims the priority of Chinese Patent Application No. 202510735386.9, filed on Jun. 3, 2025, with the title of “METHOD AND APPARATUS FOR TEXT PROCESSING BASED ON LARGE MODEL, AND METHOD AND APPARATUS FOR LARGE MODEL COMPRESSION”. The disclosure of the above application is incorporated herein by reference in its entirety.

### FIELD OF THE DISCLOSURE

The present disclosure relates to the technical field of artificial intelligence, particularly relates to the fields of deep learning, large models, and natural language processing, and more particularly relates to method and apparatus for text processing based on large model, and method and apparatus for large model compression.

### BACKGROUND OF THE DISCLOSURE

A Large model (LLM) refers to a deep learning model trained using a large amount of text data, which can generate a natural language text or understand the meaning of language text. Furthermore, a long chain-of-thought reasoning ability of a large model can be activated through reinforcement learning, thereby enabling the large model to be applicable to various simple and complex reasoning tasks.

### SUMMARY OF THE DISCLOSURE

The present disclosure provides method and apparatus for text processing based on large model, and method and apparatus for large model compression.

A method for text processing based on large model, including:
obtaining a token sequence corresponding to an input text;
performing the following processing respectively for respective tokens in the token sequence: in response to determining that a fusion layer in a target large model needs to be used to process a token, generating a target processing result corresponding to the token by executing inference computation in the fusion layer at least twice, wherein the target large model is obtained by performing a model compression on a large model to be compressed, the model compression includes fusing Lm consecutive layers in the large model to be compressed into the fusion layer, Lm is a positive integer greater than 1, and Lm is less than L, where L represents the number of layers included in the large model to be compressed.

A method for large model compression, including:
obtaining a large model to be compressed, and determining respective layers therein as candidate layers;
screening out Lm consecutive target layers from respective candidate layers according to a predetermined screening condition, wherein Lm is a positive integer greater than 1, and Lm is less than L, where L represents the number of candidate layers included in the large model to be compressed;
fusing the respective target layers into a fusion layer, to obtain a target large model as a compression result.

An electronic device, including:
at least one processor; and
a memory communicatively connected with the at least one processor;
wherein the memory stores instructions executable by the at least one processor, and the instructions are executed by the at least one processor to enable the at least one processor to perform a method for text processing based on large model, wherein the method for text processing based on large model includes:
obtaining a token sequence corresponding to an input text;
performing the following processing respectively for respective tokens in the token sequence: in response to determining that a fusion layer in a target large model needs to be used to process a token, generating a target processing result corresponding to the token by executing inference computation in the fusion layer at least twice, wherein the target large model is obtained by performing a model compression on a large model to be compressed, the model compression includes fusing Lm consecutive layers in the large model to be compressed into the fusion layer, Lm is a positive integer greater than 1, and Lm is less than L, where L represents the number of layers included in the large model to be compressed.

A non-transitory computer readable storage medium with computer instructions stored thereon, wherein the computer instructions are used for causing a method for text processing based on large model, wherein the method for text processing based on large model includes:
obtaining a token sequence corresponding to an input text;
performing the following processing respectively for respective tokens in the token sequence: in response to determining that a fusion layer in a target large model needs to be used to process a token, generating a target processing result corresponding to the token by executing inference computation in the fusion layer at least twice, wherein the target large model is obtained by performing a model compression on a large model to be compressed, the model compression includes fusing Lm consecutive layers in the large model to be compressed into the fusion layer, Lm is a positive integer greater than 1, and Lm is less than L, where L represents the number of layers included in the large model to be compressed.

It should be understood that content described in this section is not intended to identify a key or an essential feature of an embodiment of the present disclosure, nor is it used to limit the scope of the present disclosure. Other features of the present disclosure will become readily understandable through the following specification.

### BRIEF DESCRIPTION OF DRAWINGS

The drawings are used to better understand the present solution and do not constitute a limitation on the present disclosure. In the drawings:

FIG. 1 is a flowchart of a method for large model compression according to an embodiment of the present disclosure;

FIG. 2 is a schematic diagram of a sub-matrix of the present disclosure;

FIG. 3 is a schematic diagram of a large model to be compressed and a target large model of the present disclosure;

FIG. 4 is a flowchart of a method for text processing based on large model according to an embodiment of the present disclosure;

FIG. 5 is a structural diagram of an apparatus 500 for large model compression according to an embodiment of the present disclosure;

FIG. 6 is a structural diagram of apparatus 600 for text processing based on large model according to an embodiment of the present disclosure;

FIG. 7 shows a schematic block diagram of an electronic device 700 that can be used to implement an embodiment of the present disclosure.

### DETAILED DESCRIPTION OF PREFERRED EMBODIMENTS

The following description is made in conjunction with the drawings to explain an exemplary embodiment of the present disclosure, which includes various details of an embodiment of the present disclosure to aid understanding, and these should be regarded as merely exemplary. Therefore, those skilled in the art should recognize that various changes and modifications can be made to the embodiment described herein without departing from the scope and spirit of the present disclosure. Similarly, for clarity and conciseness, the description of known functions and structures is omitted in the following description.

Furthermore, it should be understood that the term “and/or” herein is merely a description of an associative relationship between associated objects, indicating that three types of relationships can exist, for example, A and/or B can indicate: A exists alone, both A and B exist simultaneously, and B exists alone. Additionally, a character “/” herein generally indicates an “or” relationship between associated objects before and after the character.

Currently, although large models have been widely applied in various scenarios, they also present certain challenges. For example, large models have a large number of parameters, requiring all parameters to be loaded during deployment, which significantly increases the memory usage of Graphics Processing Unit (GPU) or Artificial Intelligence (AI) accelerator, making it difficult for the large models to run on a resource-constrained platform.

To address the above problem, a solution according to the present disclosure proposes a method for large model compression, which can reduce the parameter scale of the large model through a compression processing on the large model, thereby reducing the memory usage of the large model during deployment. This further enables the large model to run on the resource-constrained platform, such as personal computers, mobile devices, edge devices, wearable devices, etc.

On this basis, the solution according to the present disclosure further proposes a method for text processing based on large model. Specifically, when using a compressed target large model to process a token sequence corresponding to an input text, a dynamic recursive computation method can be employed to improve the processing performance of the target large model and improve the processing efficiency of the target large model.

The following describes these two methods in detail respectively.

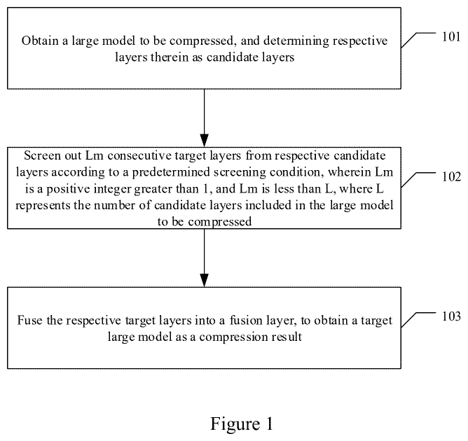

FIG. 1 is a flowchart of a method for large model compression according to an embodiment of the present disclosure. As shown in FIG. 1, the method includes the following specific implementation of:

In step 101, obtaining a large model to be compressed, and determining respective layers therein as candidate layers.

In step 102, screening out Lm consecutive target layers from respective candidate layers according to a predetermined screening condition, wherein Lm is a positive integer greater than 1, and Lm is less than L, where L represents the number of candidate layers included in the large model to be compressed.

In step 103, fusing the respective target layers into a fusion layer, to obtain a target large model as a compression result.

It can be seen that by adopting the solution described in the method embodiment, a compression processing for the large model to be compressed can be achieved by fusing the Lm screened-out consecutive target layers into a fusion layer, thereby reducing the parameter scale of the large model, and further reducing the memory usage of the large model during deployment.

A specific type of the large model to be compressed is not limited, and can be determined according to an actual need. Additionally, for ease of distinction, respective layers in the large model to be compressed are referred to respectively as a candidate layer, and respective layers screened out are referred to respectively a target layer.

In the present embodiment, Lm consecutive target layers can be screened out from respective candidate layers according to the predetermined screening condition. The specific value of Lm can be determined according to an actual need, for example, Lm can be an empirical value, or a value determined through a hyperparameter search in a series of preliminary experiments.

In some embodiments of the present disclosure, a similarity matrix of size L*L can be generated. The element Sᵢⱼ located in the i-th row and the j-th column of the similarity matrix is used to represent: a parameter similarity between the i-th candidate layer and the j-th candidate layer, 1≤i≤L, 1≤j≤L and then respective target layers can be determined based on the similarity matrix.

In other words, for each candidate layer, the parameter similarity between the candidate layer and all other layers and itself can be obtained respectively. Assuming the value of L is 10, then taking a candidate layer 1 as an example, the parameter similarities between the candidate layer 1 and candidate layers 1-10 can be obtained respectively. Accordingly, the similarity matrix S∈ [symbol] ^{L*L} can be constructed based on all the obtained parameter similarities.

In some embodiments of the present disclosure, a method for obtaining the element in the similarity matrix can include: a Distribution of Cosine Similarity (DOCS) value between respective parameter matrices in the i-th candidate layer and parameter matrices of a same type in the j-th candidate layer is respectively obtained, wherein the number of parameter matrices and the type of parameter matrices included in different candidate layers are the same, and then the Sᵢⱼ can be determined based on respective DOCS values.

To measure the parameter similarity between the respective candidate layers, the solution in the present disclosure adopts the DOCS value as an evaluation metric to improve the accuracy of the obtained parameter similarity. The DOCS value is a metric specifically designed to measure the neural network weight similarity, and the metric has a strong discriminative ability for a parameter matrix exhibiting an orthogonal property. A larger DOCS value between two parameter matrices indicates a higher degree of similarity between the two parameter matrices.

For any two candidate layers, the parameter similarity between the two candidate layers can be conveniently and accurately determined based on the corresponding parameter matrices in the two candidate layers. Accordingly, the similarity matrix can be quickly and accurately constructed, laying a good foundation for a subsequent determination of a target layer.

For example, given any two parameter matrices X and Y, X=[X₁, X₂, . . . , Xₘ]∈ [symbol] ^{n*m}, Y=[Y₁, Y₂, . . . , Yₘ]∈ [symbol] ^{n*m}, the calculation process of the DOCS value of the two parameter matrices can be as follows.

First, a cosine similarity matrix C∈ [symbol] ^{n*m} is constructed, where each element C_{j′k} represents respectively a cosine similarity between the j′-th column in the parameter matrix X and the k-th column in the parameter matrix Y, 1≤j′≤m, 1≤k≤m.

Then, for each column in the parameter matrix X, the following processing can be performed respectively: the maximum value from the cosine similarities between the column and respective columns in the parameter matrix Y is selected. In this way, the maximum values corresponding to respective columns in the parameter matrix X can be obtained, and then the maximum values corresponding to respective columns can be sorted sequentially (a more forward position of a corresponding column results in a more forward ranking), thereby a similarity vector S_{X} is obtained. In a similar way, a similarity vector S_{Y} can be obtained. That is, for each column in the parameter matrix Y, the following processing can be performed respectively: the maximum value from the cosine similarities between the column and respective columns in the parameter matrix X is selected. In this way, the maximum values corresponding to respective columns in the parameter matrix Y can be obtained, and then the maximum values corresponding to respective columns can be sorted sequentially, thereby obtaining the similarity vector S_{Y}.

The similarity vector S_{X} and the similarity vector S_{Y} represent the maximum degree of similarity between the column vector groups of the two parameter matrices. Then, a Gumbel distribution can be used to model a distribution of the two similarity vectors. Based on the modeling result, a location parameter S_{X} and a location parameter μ_{Y} can be obtained through a maximum likelihood estimation to describe a central tendency of a similarity distribution. Further, the average of the location parameter μ_{X} and the location parameter μ_{Y} can be determined as a required DOCS value.

Additionally, in some embodiments of the present disclosure, the large model to be compressed can include: a large model using a transformer architecture, and the parameter matrices in respective candidate layers can include: a first parameter matrix (Wv) corresponding to an attention module, a second parameter matrix (Wk) corresponding to the attention module, a third parameter matrix (Wq) corresponding to the attention module, a fourth parameter matrix (Wo) corresponding to the attention module, and a fifth parameter matrix corresponding to a multilayer perceptron (MLP) module.

The transformer architecture adopts a structure based on an attention mechanism, enabling the large model to have a parallel processing capability, thereby improving the computational efficiency and solving many problems such as forgetfulness and a slow training speed in a traditional neural network. In the large model using the transformer architecture, some adjacent layers show a high similarity, and are therefore more suitable for the method of model compression described in the present disclosure.

Respective candidate layers usually include the attention module and the multilayer perceptron module. The attention module usually corresponds to four parameter matrices, and the multilayer perceptron module usually corresponds to one parameter matrix. The parameter matrix can also be referred to as a weight matrix.

Accordingly, in some embodiments of the present disclosure, for the i-th candidate layer and the j-th candidate layer, a first DOCS value between the first parameter matrices in the two candidate layers, a second DOCS value between the second parameter matrices, a third DOCS value between the third parameter matrices, a fourth DOCS value between the fourth parameter matrices, and a fifth DOCS value between the fifth parameter matrices can be obtained respectively.

After obtaining the first DOCS value, the second DOCS value, the third DOCS value, the fourth DOCS value, and the fifth DOCS value respectively, the Sᵢⱼ can be further determined based on respective DOCS values.

In some embodiments of the present disclosure, the product of the first DOCS value and a first coefficient, the product of the second DOCS value and a second coefficient, the product of the third DOCS value and a third coefficient, the product of the fourth DOCS value and a fourth coefficient, and the product of the fifth DOCS value and a fifth coefficient can be obtained respectively. The sum of respective products can be obtained to obtain a first intermediate result. The first coefficient represents the number of parameters included in the first parameter matrix, the second coefficient represents the number of parameters included in the second parameter matrix, the third coefficient represents the number of parameters included in the third parameter matrix, the fourth coefficient represents the number of parameters included in the fourth parameter matrix, and the fifth coefficient represents the number of parameters included in the fifth parameter matrix. The sum of the first coefficient, the second coefficient, the third coefficient, the fourth coefficient, and the fifth coefficient can be obtained to obtain a second intermediate result, and then a ratio of the first intermediate result and the second intermediate result can be determined as the Sᵢⱼ.

That is:

$${S}_{ij} = \frac{\begin{matrix}a * DOCS ( {W}_{i}^{MLP} , {W}_{j}^{MLP} ) + b * DOCS ( {W}_{i}^{Attn 1} , {W}_{j}^{Attn 1} ) + \\ c * DOCS ( {W}_{i}^{Attn 2} , {W}_{j}^{Attn 2} ) + \\ d * DOCS ( {W}_{i}^{Attn 3} , {W}_{j}^{Attn 3} ) + e * DOCS ( {W}_{i}^{Attn 4} , {W}_{j}^{Attn 4} )\end{matrix}}{a + b + c + d + e} \qquad ( 1 )$$

In the formula (1),

$${W}_{i}^{Attn 1}$$

represents the first parameter matrix in the i-th candidate layer,

$${W}_{j}^{Attn 1}$$

represents the first parameter matrix in the j-th candidate layer,

$${W}_{i}^{Attn 2}$$

represents the second parameter matrix in the i-th candidate layer,

$${W}_{j}^{Attn 2}$$

represents the second parameter matrix in the j-th candidate layer,

$${W}_{i}^{Attn 3}$$

represents the third parameter matrix in the i-th candidate layer,

$${W}_{j}^{Attn 3}$$

represents the third parameter matrix in the j-th candidate layer,

$${W}_{i}^{Attn 4}$$

represents the fourth parameter matrix in the i-th candidate layer,

$${W}_{j}^{Attn 4}$$

represents the fourth parameter matrix in the j-th candidate layer,

$${W}_{i}^{MLP}$$

represents the fifth parameter matrix in the i-th candidate layer,

$${W}_{j}^{MLP}$$

represents the fifth parameter matrix in the j-th candidate layer, “b” represents the first coefficient, “c” represents the second coefficient, “d” represents the third coefficient, “e” represents the fourth coefficient, a represents the fifth coefficient,

$$D O C S ( {W}_{i}^{Attn 1} , {W}_{j}^{Attn 1} )$$

represents the first DOCS value,

$$D O C S ( {W}_{i}^{Attn 2} , {W}_{j}^{A ttn 2} )$$

represents the second DOCS value,

$$D O C S ( {W}_{i}^{Attn 3} , {W}_{j}^{A ttn 3} )$$

represents the third DOCS value,

$$D O C S ( {W}_{i}^{Attn 4} , {W}_{j}^{Attn 4} )$$

represents the fourth DOCS value, and

$$D O C S ( {W}_{i}^{MLP} , {W}_{j}^{MLP} )$$

represents the fifth DOCS value.

In other words, the DOCS value between respective parameter matrices in the i-th candidate layer and a corresponding parameter matrices in the j-th candidate layer can be obtained respectively. Based on respective DOCS values, a global inter-layer similarity between the i-th candidate layer and the j-th candidate layer, i.e., the Sᵢⱼ, can be determined through an operation such as an aggregation. Since the Sᵢⱼ is calculated by simultaneously fusing the DOCS values between different types of parameter matrices, the accuracy of the obtained Sᵢⱼ is improved.

Based on the constructed similarity matrix, respective target layers can be determined. Experiments have found that the case where parameters of multiple adjacent layers inside a large model show a high similarity can exist, that is, parameter similarities between these layers are generally higher than parameter similarities between other layers. Based on such an experimental observation, the solution in the present disclosure proposes to fuse adjacent layers with the high similarity to reduce a parameter redundancy inside the large model.

In some embodiments of the present disclosure, elements on the main diagonal of the similarity matrix can be determined as target elements. For each target element, the following processing can be performed respectively: in response to being able to extract a sub-matrix of size Lm*Lm from the similarity matrix with the target element as an upper-left vertex, determining a norm value of the sub-matrix according to a predetermined norm algorithm, and selecting a maximum value from respective obtained norm values, and determining a candidate layer corresponding to the sub-matrix corresponding to the maximum value as a required target layer.

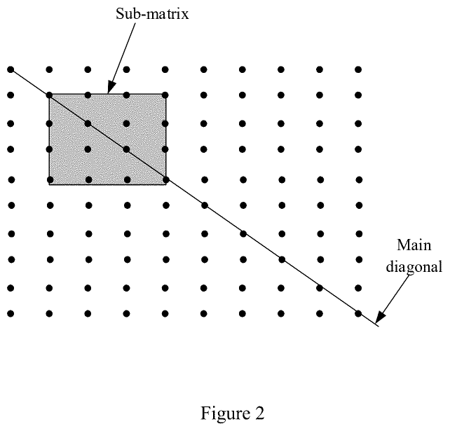

FIG. 2 is a schematic diagram of the sub-matrix of the present disclosure. As shown in FIG. 2, respective small black dots represent an element in the similarity matrix respectively. Assuming the value of Lm is 4, taking a target element located at the 2^{nd} row, the 2^{nd} column of the similarity matrix as an example, the sub-matrix shown in FIG. 2 can be extracted.

As a possible implementation, for each sub-matrix, a Frobenius norm value of the sub-matrix can be obtained respectively, and then the maximum value can be selected from all the obtained norm values. Assuming the sub-matrix corresponding to the maximum value is the sub-matrix shown in FIG. 2, then respective candidate layers corresponding to the sub-matrix (i.e., candidate layer 2 to candidate layer 5) can be determined as target layers.

It can be seen that by adopting the above processing method, the target layers can be efficiently and accurately screened out from respective candidate layers with only a simple operation such as a sub-matrix extraction and a norm value calculation.

Then, respective target layers can be fused into a fusion layer, thereby obtaining the target large model as the compression result.

In some embodiments of the present disclosure, for different types of parameter matrices, the following processing can be performed respectively: the average of the parameter matrices of the type in respective target layers is obtained, and then respective averages obtained are determined as a parameter matrix in the fusion layer, thereby obtaining the fusion layer.

That is:

$${W}^{n e w} = \frac{1}{{L}_{m}} {\sum }_{{i}^{′}}^{{i}^{′} + {L}_{m} - 1} {W}_{{i}^{′}}^{old} \qquad ( 2 )$$

In the formula (2),

$${W}_{{i}^{′}}^{old}$$

represents a certain type of parameter matrix in respective target layers. The sum of the parameter matrices of the type in respective target layers can be obtained (element-wise calculation), and then the obtained sum can be divided by Lm (element-wise calculation) to obtain an average W^{new} of the parameter matrices of the type in respective target layers. W^{new} represents the parameter matrix of the type in the fusion layer.

Specifically, assuming the number of target layers is 4, then an average of the first parameter matrices in the 4 target layers, an average of the second parameter matrices in the 4 target layers, an average of the third parameter matrices in the 4 target layers, an average of the fourth parameter matrices in the 4 target layers, and an average of the fifth parameter matrices in the 4 target layers can be obtained respectively, thereby obtaining the first parameter matrix, the second parameter matrix, the third parameter matrix, the fourth parameter matrix, and the fifth parameter matrix in the fusion layer respectively.

Through the above processing, a fusion compression of model parameters can be realized. The degree of compression can be controlled by adjusting the hyperparameter Lm. A larger value of Lm means more layers are fused and compressed, but correspondingly, it is also prone to cause an over-compression, fusing some non-redundant layers and leading to an excessive performance loss. Therefore, the value of Lm needs to be set appropriately. In practical applications, the value of Lm can be determined through a series of preliminary experiments to conduct a hyperparameter search. That is, an optimal degree of compression is determined that does not cause a performance collapse.

In summary, by adopting the model compression method of the present disclosure, an inter-layer parameter redundancy inside the large model can be utilized. Through an operation such as a similarity measurement and a parameter fusion, the number of model layers is reduced, thereby reducing the parameter scale of the large model, and further reducing the memory usage during deployment and improving a running speed.

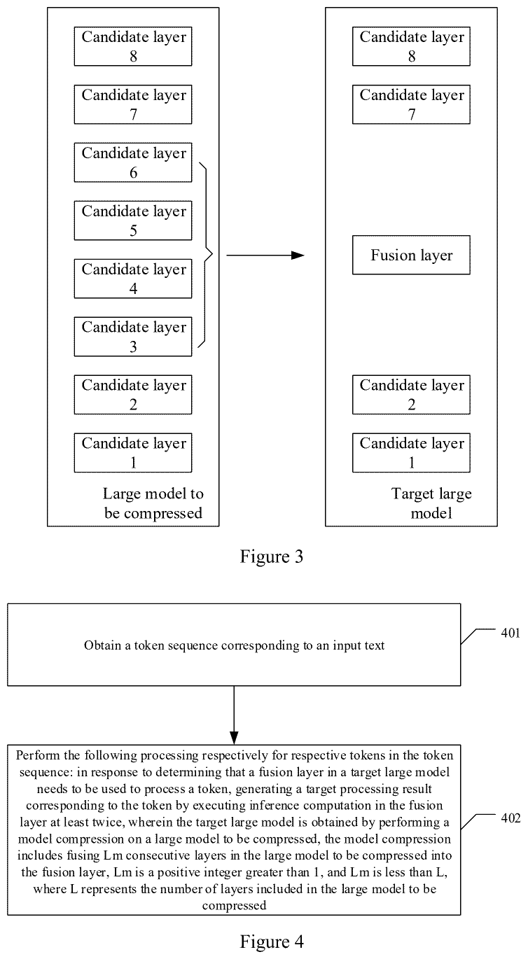

FIG. 3 is a schematic diagram of the large model to be compressed and the target large model of the present disclosure. As shown in FIG. 3, assuming the large model to be compressed includes 8 candidate layers, which are candidate layer 1 to candidate layer 8, and assuming candidate layer 3, candidate layer 4, candidate layer 5, and candidate layer 6 are screened out as target layers, then the candidate layer 3, the candidate layer 4, the candidate layer 5, and the candidate layer 6 can be fused into one fusion layer, thereby obtaining a required target large model.

The solution in the present disclosure also proposes a method for applying/using the method of the target large model, which is described in detail through the following embodiment.

FIG. 4 is a flowchart of a method for text processing based on large model according to an embodiment of the present disclosure. As shown in FIG. 4, the method includes the following specific implementation of:

In step 401, obtaining a token sequence corresponding to an input text.

In step 402, performing the following processing respectively for respective tokens in the token sequence: in response to determining that a fusion layer in a target large model needs to be used to process a token, generating a target processing result corresponding to the token by executing inference computation in the fusion layer at least twice, wherein the target large model is obtained by performing a model compression on a large model to be compressed, the model compression includes fusing Lm consecutive layers in the large model to be compressed into the fusion layer, Lm is a positive integer greater than 1, and Lm is less than L, where L represents the number of layers included in the large model to be compressed.

Performing the model compression on the large model to be compressed will lead to a decrease in the number of layers of the large model, which can cause a decrease in the representation capability of the large model and affect the performance of the large model. Therefore, in order to compensate for a performance loss caused by the decrease in the number of layers, the solution in the present disclosure proposes an idea of multiple cyclic computation. That is, physically, parameters of only one layer (the fusion layer) are retained, but the data flow is allowed to pass through the layer multiple times, thereby logically expanding the layer into multiple layers. Thereby, the effective depth of the large model is maintained while reducing the parameter scale of the large model. That is, a decrease in the representation capability of the large model caused by the decrease in the number of layers is compensated through the cyclic computation, thereby improving the performance of the large model.

Such architecture also provides large models with another advantage: the number of the cyclic computation can be adaptively adjusted according to the difficulty of the task, that is, a dynamic recursive computation method can be adopted.

In practical applications, for respective tokens of the token sequence, the target large model can process respective tokens sequentially in a predetermined order. In the present embodiment, for the fusion layer, different numbers of cyclic computations can be used for different tokens. That is, more cyclic computations can be automatically invested at key points on the inference path.

Accordingly, in some embodiments of the present disclosure, for each token, an original input of the token corresponding to the fusion layer can be determined respectively, and inference computation can be performed on the original input using the fusion layer, and then the following predetermined processing can be executed: an inference computation is performed on a most recently obtained computation result using the fusion layer, the most recently obtained computation result is determined as a candidate result, and the computation result obtained immediately before the candidate result is determined as a reference result; in response to determining that a termination condition is met based on the candidate result and the reference result, the candidate result can be determined as a target processing result, and in response to determining that the termination condition is not met, the predetermined processing can be repeated.

Taking a certain token “a” in the token sequence as an example, for other layers other than the fusion layer in the target large model, the token “a” can be processed in a traditional way. When the fusion layer needs to be used to process the token “a”, the inference computation in the fusion layer needs to be executed at least twice. Specifically, the original input corresponding to the token “a” can be obtained first, for example, a computation result 0 corresponding to the token “a” generated by a previous layer of the fusion layer. Then, the inference computation can be performed on the original input using the fusion layer to obtain a computation result 1. Further, the inference computation can be performed on the computation result 1 using the fusion layer to obtain a computation result 2. The computation result 2 can be determined as the candidate result, and the computation result 1 can be determined as the reference result. Then, it can be determined whether the termination condition is met based on the candidate result and the reference result. Assuming that the termination condition is not met, the inference computation can be performed on the computation result 2 using the fusion layer to obtain a computation result 3. The computation result 3 can be determined as the candidate result, and the computation result 2 can be determined as the reference result. Then, it can be determined whether the termination condition is met based on the candidate result and the reference result. Assuming that the termination condition is met, the candidate result, i.e., the computation result 3, can be determined as a required target processing result.

The cyclic computation process can be expressed as follows:

$${x}_{t} = f ( {x}_{t - 1} ; {θ}_{L a y e r} ) ; \qquad ( 3 )$$

In the formula (3), “f” represents the inference computation performed in the fusion layer, θ_{Layer} represents all parameters in the fusion layer, xₜ₋₁ represents a computation result obtained from a previous inference computation, and xₜ represents a computation result obtained from a most recent inference computation.

Through the above processing, the number of cyclic computations corresponding to a different token can be automatically determined, thereby optimizing the target large model into a large model of a variable depth. That is, the effective depth of the target large model can be dynamically adjusted adaptively according to the task difficulty. In this way, for a simple token processing task, not only a redundant computation is reduced through the model compression, but also the number of cyclic computations can be reduced, thereby improving the processing efficiency, reducing the time delay, and improving the resource utilization rate. For a complex token processing task, a deeper large model can be simulated by increasing the number of cyclic computations, thereby improving the accuracy of a processing result.

In some embodiments of the present disclosure, when determining whether the termination condition is met based on the candidate result and the reference result, a Latent Semantic Saturation (LSS) can be determined first based on the candidate result and the reference result, and then the LSS can be compared with a predetermined threshold. In response to determining that the LSS is greater than the threshold, it can be determined that the termination condition is met.

That is, the LSS can be used as a cyclic stopping indicator. Once it is determined that an obtained LSS is greater than the threshold, the cycle can be ended, and the most recently obtained computation result can be determined as the target processing result.

In some embodiments of the present disclosure, a method for determining the LSS based on the candidate result and the reference result can include: a transpose operation is performed on the candidate result, a first product of a transpose operation result and the reference result is obtained, a second product of a norm of the candidate result and a norm of the reference result is obtained, and a ratio of the first product and the second product is determined as the LSS.

That is:

$$L S S ( {x}_{t} , {x}_{t - 1} ) = \frac{{x}_{t}^{T} {x}_{t - 1}}{‖ {x}_{t} ‖ \cdot ‖ {x}_{t - 1} ‖} ; \qquad ( 4 )$$

In the formular (4), xₜ represents the candidate result, and xₜ₋₁ represents the reference result.

The LSS measures a cosine similarity between the computation results obtained from two adjacent inference computations. If the LSS is less than or equal to the threshold, it indicates that a latent representation (the computation result) obtained after a most recent inference computation has a relatively large change compared to a previous one, and a latent vector still has the room for an optimization and a deduction, so a next inference computation can continue to be executed. If the LSS is greater than the threshold, it indicates that an impact of the cyclic computation on the latent vector has approached a saturation, and a current latent vector already contains sufficient information for an inference computation of a subsequent layer, so the cyclic computation can be stopped, and the most recently obtained computation result can be sent to the subsequent layer for processing.

A specific value of the threshold can be determined according to an actual need. For example, the threshold can be an empirical value, or a value determined through a hyperparameter search in a series of preliminary experiments.

In some embodiments of the present disclosure, in response to determining that the termination condition is not met based on the candidate result and the reference result, but determining that the fusion layer has been used for T times of inference computation, the candidate result can be determined as the target processing result, where T is a positive integer greater than 2.

That is, a maximum number of cyclic computations T can be set. Once the value reached, even if the termination condition is not met, the cycle can be forcibly ended, and a most recently determined candidate result can be directly determined as the target processing result, thereby avoiding a problem such as an excessive time delay caused by too many cyclic computations.

The method for text processing based on large model of the present disclosure can be further illustrated as follows: assuming a user inputs a text to the target large model shown in FIG. 3, a token sequence corresponding to the text can be obtained, and then respective tokens in the token sequence can be processed sequentially. Wherein, for any token, the token can be processed in an order of a candidate layer 1, a candidate layer 2, a fusion layer, a candidate layer 7, and a candidate layer 8, respectively. Processing method of the candidate layer 1, the candidate layer 2, the candidate layer 7, and the candidate layer 8 are all the same as the traditional method, that is, generating an output computation result through an inference computation based on an input content. For the fusion layer, the cyclic computation method in the solution of the present disclosure can be adopted to obtain a required target processing result.

It should be noted that for the foregoing method embodiments, for a simple description, each method embodiment is described as a series of action combinations, but a person skilled in the art should know that the present disclosure is not limited by a described action sequence, because according to the present disclosure, some steps can be performed in another order or simultaneously. Secondly, a person skilled in the art should also know that an embodiment described in the specification is a preferred embodiment, and an action and a module involved are not necessarily required by the present disclosure. In addition, a part not detailed in a certain embodiment can refer to a relevant description in another embodiment.

The above is an introduction to a method embodiment, and the following further explains the solution of the present disclosure through an apparatus embodiment.

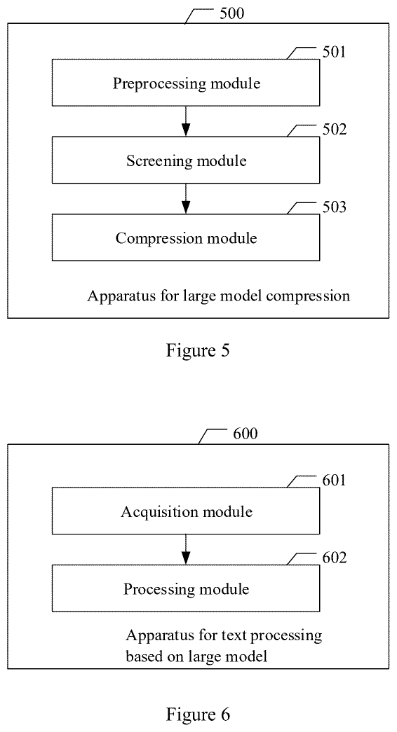

FIG. 5 is a structural diagram of an apparatus 500 for large model compression according to an embodiment of the present disclosure. As shown in FIG. 5, the apparatus includes: a preprocessing module 501, a screening module 502, and a compression module 503.

The preprocessing module 501 is configured to a large model to be compressed, and determine respective layers therein as candidate layers.

The screening module 502 is configured to screen out Lm consecutive target layers from respective candidate layers according to a predetermined screening condition, wherein Lm is a positive integer greater than 1, and Lm is less than L, where L represents the number of candidate layers included in the large model to be compressed.

The compression module 503 is configured to fuse the respective target layers into a fusion layer, to obtain a target large model as a compression result.

In some embodiments of the present disclosure, the screening module 502 can generate a similarity matrix of size L*L. The element Sᵢⱼ located in the i-th row and the j-th column of the similarity matrix is used to represent: a parameter similarity between the i-th candidate layer and the j-th candidate layer, 1≤i≤L, 1≤j≤L, and then respective target layers can be determined based on the similarity matrix.

In some embodiments of the present disclosure, a method for the screening module 502 to obtain the Sᵢⱼ can include: a DOCS value between respective parameter matrices in the i-th candidate layer and parameter matrices of a same type in the j-th candidate layer is obtained, wherein the number of parameter matrices and the type of parameter matrices included in different candidate layers are the same, and then the Sᵢⱼ can be determined based on respective DOCS values.

In some embodiments of the present disclosure, the large model to be compressed can include: a large model using a Transformer architecture, and parameter matrices in respective candidate layers can include: a first parameter matrix corresponding to an attention module, a second parameter matrix corresponding to the attention module, a third parameter matrix corresponding to the attention module, a fourth parameter matrix corresponding to the attention module, and a fifth parameter matrix corresponding to a multilayer perceptron module; Accordingly, for the i-th candidate layer and the j-th candidate layer, the screening module 502 can obtain a first DOCS value between the first parameter matrices in the two candidate layers, a second DOCS value between the second parameter matrices, a third DOCS value between the third parameter matrices, a fourth DOCS value between the fourth parameter matrices, and a fifth DOCS value between the fifth parameter matrices respectively.

After obtaining the first DOCS value, the second DOCS value, the third DOCS value, the fourth DOCS value, and the fifth DOCS value respectively, the screening module 502 can further determine the Sᵢⱼ based on respective DOCS values.

In some embodiments of the present disclosure, the screening module 502 can obtain the product of the first DOCS value and a first coefficient, the product of the second DOCS value and a second coefficient, the product of the third DOCS value and a third coefficient, the product of the fourth DOCS value and a fourth coefficient, and the product of the fifth DOCS value and a fifth coefficient respectively, and obtain the sum of respective products to get a first intermediate result. The first coefficient represents the number of parameters included in the first parameter matrix, the second coefficient represents the number of parameters included in the second parameter matrix, the third coefficient represents the number of parameters included in the third parameter matrix, the fourth coefficient represents the number of parameters included in the fourth parameter matrix, and the fifth coefficient represents the number of parameters included in the fifth parameter matrix. And the sum of the first coefficient, the second coefficient, the third coefficient, the fourth coefficient, and the fifth coefficient can be obtained to get a second intermediate result, and then a ratio of the first intermediate result and the second intermediate result can be determined as the Sᵢⱼ.

Based on the constructed similarity matrix, respective target layers can be determined. In some embodiments of the present disclosure, the screening module 502 can determine an element on a main diagonal of the similarity matrix as a target element. For each target element, perform the following processing: in response to being able to extract a sub-matrix of size Lm*Lm from the similarity matrix with the target element as an upper-left vertex, a norm value of the sub-matrix is determined according to a predetermined norm algorithm, and the maximum value is selected from respective obtained norm values, and a candidate layer corresponding to the sub-matrix corresponding to the maximum value is determined as a required target layer.

Then, the compression module 503 can fuse respective target layers into a fusion layer, thereby obtaining the target large model as the compression result. In some embodiments of the present disclosure, for a different type of parameter matrix, the compression module 503 can perform the following processing respectively: an average of the parameter matrices of the type in respective target layers is obtained, and then respective obtained averages are determined as a parameter matrix in the fusion layer, thereby obtaining the fusion layer.

FIG. 6 is a structural diagram of apparatus 600 for text processing based on large model according to an embodiment of the present disclosure. As shown in FIG. 6, the apparatus 600 includes an acquisition module 601 and a processing module 602.

The acquisition module 601 is configured to obtain a token sequence corresponding to an input text.

The processing module 602 is configured to perform the following processing respectively for respective tokens in the token sequence: in response to determining that a fusion layer in a target large model needs to be used to process a token, generating a target processing result corresponding to the token by executing inference computation in the fusion layer at least twice, wherein the target large model is obtained by performing a model compression on a large model to be compressed, the model compression includes fusing Lm consecutive layers in the large model to be compressed into the fusion layer, Lm is a positive integer greater than 1, and Lm is less than L, where L represents the number of layers included in the large model to be compressed.

In some embodiments of the present disclosure, for each token, the processing module 602 can determine an original input of the token corresponding to the fusion layer, perform inference computation on the original input using the fusion layer, and then execute the following predetermined processing: perform inference computation on a most recently obtained computation result using the fusion layer, determine the most recently obtained computation result as a candidate result, and determine a computation result obtained immediately before the candidate result as a reference result; in response to determining that a termination condition is met based on the candidate result and the reference result, the candidate result can be determined as a target processing result, and in response to determining that the termination condition is not met, the predetermined processing can be repeated.

In some embodiments of the present disclosure, when determining whether the termination condition is met based on the candidate result and the reference result, the processing module 602 can first determine an LSS based on the candidate result and the reference result, and then compare the LSS with a predetermined threshold. In response to determining that the LSS is greater than the threshold, it can be determined that the termination condition is met.

In some embodiments of the present disclosure, a method for the processing module 602 to determine the LSS based on the candidate result and the reference result can include: performing a transpose operation on the candidate result, obtaining a first product of a transpose operation result and the reference result, obtaining a second product of a norm of the candidate result and a norm of the reference result, and determining a ratio of the first product and the second product as the LSS.

Additionally, in some embodiments of the present disclosure, in response to determining that the termination condition is not met based on the candidate result and the reference result, but determining that the fusion layer has been used for T times of inference computation, the processing module 602 can determine the candidate result as the target processing result, where T is a positive integer greater than 2.

A specific operating flow of each apparatus embodiment described above can refer to a relevant description in the previous method embodiments and will not be repeated here.

In summary, by adopting the solution of the present disclosure, a model compression can be combined with a dynamic recursive computation, which not only reduces a parameter scale and a computational redundancy of a target large model, but also improves a processing efficiency and a resource utilization rate of the target large model, and improves an accuracy of a processing result of the target large model. Moreover, compared to a traditional large model with an internal parameter redundancy and a fixed depth, the target large model can exhibit powerful flexibility and scalability, thereby meeting a use requirement in a different scenario.

The solution of the present disclosure can be applied in an artificial intelligence field, and particularly relates to a field such as deep learning, a large model, and natural language processing. The artificial intelligence is a discipline that studies how to make a computer to simulate certain thought process and intelligent behavior (such as learning, reasoning, thinking, planning, etc.) of human, and includes both hardware level technology and software level technology. An artificial intelligence hardware technology generally includes the technology such as sensor, dedicated artificial intelligence chip, cloud computing, distributed storage, big data processing, etc. An artificial intelligence software technology mainly includes computer vision technology, speech recognition technology, natural language processing technology, and machine learning/deep learning, big data processing technology, knowledge graph technology, etc.

In addition, the text and other information described in the embodiments of this disclosure are not specific to a specific user and do not reflect the personal information of a specific user. The collection, storage, use, processing, transmission, provision, and disclosure of user personal information in the technical solutions of this disclosure comply with relevant laws and regulations and do not violate public order and good morals.

According to embodiments of the present disclosure, the present disclosure also provides an electronic device, a readable storage medium, and a computer program product.

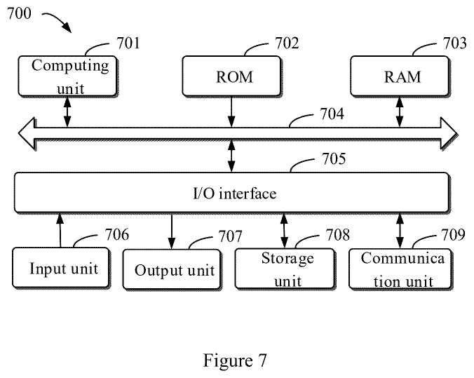

FIG. 7 shows a schematic block diagram of an electronic device 700 that can be used to implement an embodiment of the present disclosure. The electronic device is intended to represent various forms of a digital computer, such as a laptop computer, a desktop computer, a workstation, a server, a blade server, a mainframe computer, and other suitable computer. The electronic device can also represent various forms of a mobile device, such as a personal digital assistant, a cellular telephone, a smart phone, a wearable device, and other similar computing device. A component shown herein, a connection and a relationship thereof, and a function thereof are merely an example, and are not intended to limit an implementation of the present disclosure described and/or claimed herein.

As shown in FIG. 7, the electronic device 700 includes a computing unit 701, which can execute various appropriate actions and processing according to a computer program stored in a Read-Only Memory (ROM) 702 or a computer program loaded from a storage unit 708 to a Random Access Memory (RAM) 703. In the RAM 703, various programs and data required for an operation of the electronic device 700 can also be stored. The computing unit 701, the ROM 702, and the RAM 703 are interconnected via a bus 704. An Input/Output (I/O) interface 705 is also connected to the bus 704.

Multiple components in the electronic device 700 are connected to the I/O interface 705, including: an input unit 706, such as a keyboard, a mouse, etc.; an output unit 707, such as various types of a display, a speaker, etc.; a storage unit 708, such as a magnetic disk, an optical disk, etc.; and a communication unit 709, such as a network card, a modem, a wireless communication transceiver, etc. The communication unit 709 allows the electronic device 700 to exchange an information/data with another device through a computer network such as an Internet and/or various telecommunication networks.

The computing unit 701 can be various general-purpose and/or dedicated processing components with a processing and a computing capability. Some examples of the computing unit 701 include but are not limited to a Central Processing Unit (CPU), a Graphic Processing Unit (GPU), various dedicated Artificial Intelligence (AI) computing chips, various computing units running a machine learning model algorithm, a Digital Signal Processing (DSP), and any appropriate processor, controller, microcontroller, etc. The computing unit 701 executes the various methods and processing described above, for example, the method of the present disclosure. For example, in some embodiments, the method of the present disclosure can be implemented as a computer software program, which is tangibly contained in a machine-readable medium, for example, the storage unit 708. In some embodiments, a part or all of the computer program can be loaded and/or installed onto the electronic device 700 via the ROM 702 and/or the communication unit 709. When the computer program is loaded into the RAM 703 and executed by the computing unit 701, one or more steps of the method of the present disclosure can be executed. Alternatively, in other embodiments, the computing unit 701 can be configured to execute the method of the present disclosure by any other appropriate means (for example, by means of a firmware).

Various implementations of a system and a technology described herein can be implemented in a digital electronic circuit system, an integrated circuit system, a Field Programmable Gate Array (FPGA), an Application Specific Integrated Circuit (ASIC), an Application Specific Standard Parts (ASSP), a System on Chip (SOC), a Complex Programmable Logic Device (CPLD), a computer hardware, a firmware, a software, and/or a combination thereof. These various implementations can include: implementation in one or more computer programs, the one or more computer programs can be executed and/or interpreted on a programmable system including at least one programmable processor, the programmable processor can be a dedicated or a general-purpose programmable processor, can receive a data and an instruction from a storage system, at least one input device, and at least one output device, and transmit the data and the instruction to the storage system, the at least one input device, and the at least one output device.

A program code for implementing the method of the present disclosure can be written in any combination of one or more programming languages. These program codes can be provided to a processor or a controller of a general-purpose computer, a special-purpose computer, or other programmable data processing apparatus, such that the program code, when executed by the processor or the controller, causes a function/operation specified in a flowchart and/or a block diagram to be implemented. The program code can be executed entirely on a machine, partly on the machine, as a stand-alone software package partly on the machine and partly on a remote machine, or entirely on the remote machine or a server.

In the context of the present disclosure, a machine-readable medium can be a tangible medium, which can contain or store a program for use by or in connection with an instruction execution system, an apparatus, or a device. The machine-readable medium can be a machine-readable signal medium or a machine-readable storage medium. The machine-readable medium can include but is not limited to an electronic, a magnetic, an optical, an electromagnetic, an infrared, or a semiconductor system, apparatus, or device, or any suitable combination of the foregoing. More specific examples of the machine-readable storage medium would include an electrical connection based on one or more wires, a portable computer disk, a hard disk, a random access memory, a read-only memory, an erasable programmable read-only memory (EPROM), a flash memory, an optical fiber, a portable compact disc read-only memory (CD-ROM), an optical storage device, a magnetic storage device, or any suitable combination of the foregoing.

To provide an interaction with a user, a system and a technology described here can be implemented on a computer, the computer having: a display device for displaying an information to the user (for example, a Cathode Ray Tube (CRT) or a Liquid Crystal Display (LCD) monitor); and a keyboard and a pointing device (for example, a mouse or a trackball), through which the user can provide an input to the computer. Other kinds of a device can also be used to provide the interaction with the user; for example, a feedback provided to the user can be any form of a sensory feedback (for example, a visual feedback, an auditory feedback, or a tactile feedback); and an input from the user can be received in any form (including an acoustic input, a speech input, or a tactile input).

A system and a technology described here can be implemented in a computing system including a back-end component (for example, as a data server), or a computing system including a middleware component (for example, an application server), or a computing system including a front-end component (for example, a user computer having a graphical user interface or a web browser, through which the user can interact with an implementation of the system and the technology described here), or a computing system including any combination of such a back-end component, a middleware component, or a front-end component. Components of the system can be interconnected by any form or a medium of a digital data communication (for example, a communication network). Examples of the communication network include: a Local Area Network (LAN), a Wide Area Network (WAN), and an Internet.

A computer system can include a client and a server. The client and the server are generally remote from each other and usually interact through a communication network. A relationship between the client and the server is generated by a computer program running on a corresponding computer and having a client-server relationship with each other. The server can be a 2cloud server, or a server of a distributed system, or a server combined with a blockchain.

It should be understood that various forms of a flow shown above can be used, and a step can be reordered, added, or deleted. For example, each step described in the present disclosure can be executed in parallel, sequentially, or in a different order, as long as a desired result of a technical solution disclosed in the present disclosure can be achieved, which is not limited herein.

The above specific embodiments do not constitute the limitation on the protection scope of the present disclosure. A person skilled in the art should understand that, according to the design requirement and other factors, various modifications, combinations, sub-combinations, and substitutions can be made. Any modification, equivalent substitution, and improvement made within a spirit and a principle of the present disclosure should be included within the protection scope of the present disclosure.

What is claimed is:

1. A method for text processing based on large model, comprising:
obtaining a token sequence corresponding to an input text;
performing the following processing respectively for respective tokens in the token sequence: in response to determining that a fusion layer in a target large model needs to be used to process a token, generating a target processing result corresponding to the token by executing inference computation in the fusion layer at least twice, wherein the target large model is obtained by performing a model compression on a large model to be compressed, the model compression comprises fusing Lm consecutive layers in the large model to be compressed into the fusion layer, Lm is a positive integer greater than 1, and Lm is less than L, where L represents the number of layers included in the large model to be compressed.

2. The method according to claim 1, wherein generating the target processing result corresponding to the token by executing inference computation in the fusion layer at least twice comprises:
determining an original input corresponding to the token for the fusion layer, performing inference computation on the original input using the fusion layer, and executing the following predetermined processing:
performing inference computation on a most recently obtained computation result using the fusion layer, determining the most recently obtained computation result as a candidate result, and determining a computation result obtained immediately before the candidate result as a reference result; in response to determining that a termination condition is met based on the candidate result and the reference result, determining the candidate result as the target processing result, and in response to determining that the termination condition is not met, repeating the predetermined processing.

3. The method according to claim 2, wherein determining that the termination condition is met based on the candidate result and the reference result comprises:
determining a latent semantic saturation based on the candidate result and the reference result;
in response to determining that the latent semantic saturation is greater than a predetermined threshold, determining that the termination condition is met.

4. The method according to claim 3, wherein determining the latent semantic saturation based on the candidate result and the reference result comprises:
performing a transpose operation on the candidate result, and obtaining a first product of a transpose operation result and the reference result;
obtaining a second product of a norm of the candidate result and a norm of the reference result;
determining a ratio of the first product to the second product as the latent semantic saturation.

5. The method according to claim 2, further comprising:
in response to determining that the termination condition is not met based on the candidate result and the reference result, but determining that the fusion layer has been used for inference computation T times, determining the candidate result as the target processing result, wherein T is a positive integer greater than 2.

6. A method for large model compression, comprising:
obtaining a large model to be compressed, and determining respective layers therein as candidate layers;
screening out Lm consecutive target layers from respective candidate layers according to a predetermined screening condition, wherein Lm is a positive integer greater than 1, and Lm is less than L, where L represents the number of candidate layers included in the large model to be compressed;
fusing the respective target layers into a fusion layer, to obtain a target large model as a compression result.

7. The method according to claim 6, wherein screening out the Lm consecutive target layers from the respective candidate layers comprises:
generating a similarity matrix of size L*L, wherein an element Sᵢⱼ located in the i-th row and the j-th column of the similarity matrix is used to represent: a parameter similarity between the i-th candidate layer and the j-th candidate layer, 1≤i≤L, 1≤j≤L;
determining the target layers based on the similarity matrix.

8. The method according to claim 7, wherein obtaining the Sᵢⱼ comprises:
obtaining a cosine similarity distribution value between respective parameter matrices in the i-th candidate layer and parameter matrices of the same type in the j-th candidate layer, wherein the number of parameter matrices and the type of parameter matrices included in different candidate layers are the same;
determining the Sᵢⱼ based on respective cosine similarity distribution values.

9. The method according to claim 8, wherein
the parameter matrices in respective candidate layers respectively comprise: a first parameter matrix corresponding to an attention module, a second parameter matrix corresponding to the attention module, a third parameter matrix corresponding to the attention module, a fourth parameter matrix corresponding to the attention module, and a fifth parameter matrix corresponding to a multilayer perceptron module;
obtaining respectively the cosine similarity distribution value between respective parameter matrices in the i-th candidate layer and parameter matrices of the same type in the j-th candidate layer comprises: obtaining a first cosine similarity distribution value between the first parameter matrices in the two candidate layers, a second cosine similarity distribution value between the second parameter matrices in the two candidate layers, a third cosine similarity distribution value between the third parameter matrices in the two candidate layers, a fourth cosine similarity distribution value between the fourth parameter matrices in the two candidate layers, and a fifth cosine similarity distribution value between the fifth parameter matrices in the two candidate layers.

10. The method according to claim 9, wherein determining the Sᵢⱼ based on respective cosine similarity distribution values comprises:
obtaining a product of the first cosine similarity distribution value and a first coefficient, a product of the second cosine similarity distribution value and a second coefficient, a product of the third cosine similarity distribution value and a third coefficient, a product of the fourth cosine similarity distribution value and a fourth coefficient, and a product of the fifth cosine similarity distribution value and a fifth coefficient, and obtaining a sum of respective products to obtain a first intermediate result, wherein the first coefficient represents the number of parameters included in the first parameter matrix, the second coefficient represents the number of parameters included in the second parameter matrix, the third coefficient represents the number of parameters included in the third parameter matrix, the fourth coefficient represents the number of parameters included in the fourth parameter matrix, and the fifth coefficient represents the number of parameters included in the fifth parameter matrix;
obtaining a sum of the first coefficient, the second coefficient, the third coefficient, the fourth coefficient, and the fifth coefficient to obtain a second intermediate result;
determining a ratio of the first intermediate result and the second intermediate result as the Sᵢⱼ.

11. The method according to claim 7, wherein determining the target layers based on the similarity matrix comprises:
determining an element on a main diagonal of the similarity matrix as a target element;
performing the following processing for each target element: in response to being able to extract a sub-matrix of size Lm*Lm from the similarity matrix with the target element as an upper-left vertex, determining a norm value of the sub-matrix according to a predetermined norm algorithm;
selecting a maximum value from respective obtained norm values, and determining candidate layers corresponding to the sub-matrix corresponding to the maximum value as the target layers.

12. The method according to claim 8, wherein fusing the respective target layers into the fusion layer comprises:
performing the following processing for a different type of parameter matrix: obtaining an average of the parameter matrices of the type in the respective target layers;
determining respective obtained averages as a parameter matrix in the fusion layer to obtain the fusion layer.

13. An electronic device, comprising:
at least one processor; and
a memory communicatively connected with the at least one processor;
wherein the memory stores instructions executable by the at least one processor, and the instructions are executed by the at least one processor to enable the at least one processor to perform a method for text processing based on large model, wherein the method for text processing based on large model comprises:
obtaining a token sequence corresponding to an input text;
performing the following processing respectively for respective tokens in the token sequence: in response to determining that a fusion layer in a target large model needs to be used to process a token, generating a target processing result corresponding to the token by executing inference computation in the fusion layer at least twice, wherein the target large model is obtained by performing a model compression on a large model to be compressed, the model compression comprises fusing Lm consecutive layers in the large model to be compressed into the fusion layer, Lm is a positive integer greater than 1, and Lm is less than L, where L represents the number of layers included in the large model to be compressed.

14. The electronic device according to claim 13, wherein generating the target processing result corresponding to the token by executing inference computation in the fusion layer at least twice comprises:
determining an original input corresponding to the token for the fusion layer, performing inference computation on the original input using the fusion layer, and executing the following predetermined processing:
performing inference computation on a most recently obtained computation result using the fusion layer, determining the most recently obtained computation result as a candidate result, and determining a computation result obtained immediately before the candidate result as a reference result; in response to determining that a termination condition is met based on the candidate result and the reference result, determining the candidate result as the target processing result, and in response to determining that the termination condition is not met, repeating the predetermined processing.

15. The electronic device according to claim 14, wherein determining that the termination condition is met based on the candidate result and the reference result comprises:
determining a latent semantic saturation based on the candidate result and the reference result;
in response to determining that the latent semantic saturation is greater than a predetermined threshold, determining that the termination condition is met.

16. The electronic device according to claim 15, wherein determining the latent semantic saturation based on the candidate result and the reference result comprises:
performing a transpose operation on the candidate result, and obtaining a first product of a transpose operation result and the reference result;
obtaining a second product of a norm of the candidate result and a norm of the reference result;
determining a ratio of the first product to the second product as the latent semantic saturation.

17. The electronic device according to claim 14, further comprising:
in response to determining that the termination condition is not met based on the candidate result and the reference result, but determining that the fusion layer has been used for inference computation T times, determining the candidate result as the target processing result, wherein T is a positive integer greater than 2.

18. A non-transitory computer readable storage medium with computer instructions stored thereon, wherein the computer instructions are used for causing a method for text processing based on large model, wherein the method for text processing based on large model comprises:
obtaining a token sequence corresponding to an input text;
performing the following processing respectively for respective tokens in the token sequence: in response to determining that a fusion layer in a target large model needs to be used to process a token, generating a target processing result corresponding to the token by executing inference computation in the fusion layer at least twice, wherein the target large model is obtained by performing a model compression on a large model to be compressed, the model compression comprises fusing Lm consecutive layers in the large model to be compressed into the fusion layer, Lm is a positive integer greater than 1, and Lm is less than L, where L represents the number of layers included in the large model to be compressed.

19. The non-transitory computer readable storage medium according to claim 18, wherein generating the target processing result corresponding to the token by executing inference computation in the fusion layer at least twice comprises:
determining an original input corresponding to the token for the fusion layer, performing inference computation on the original input using the fusion layer, and executing the following predetermined processing:
performing inference computation on a most recently obtained computation result using the fusion layer, determining the most recently obtained computation result as a candidate result, and determining a computation result obtained immediately before the candidate result as a reference result; in response to determining that a termination condition is met based on the candidate result and the reference result, determining the candidate result as the target processing result, and in response to determining that the termination condition is not met, repeating the predetermined processing.

20. The non-transitory computer readable storage medium according to claim 19, wherein determining that the termination condition is met based on the candidate result and the reference result comprises:
determining a latent semantic saturation based on the candidate result and the reference result;
in response to determining that the latent semantic saturation is greater than a predetermined threshold, determining that the termination condition is met.
